(19) United States
(12) Patent Application Publication
(10) Pub. No.: US 2025/0008614 A1
(43) Pub. Date: Jan. 2, 2025

(54) ELECTRIC TARP DEFROSTER

(71) Applicant: DEAN ALAN FELLER, RENSSELAER, IN (US)

(72) Inventor: DEAN ALAN FELLER, RENSSELAER, IN (US)

(21) Appl. No.: 18/761,222

(22) Filed: Jul. 1, 2024

Related U.S. Application Data
(60) Provisional application No. 63/511,489, filed on Jun. 30, 2023.

(51) Int. Cl. H05B 3/34; B60J 11/04; H05B 1/02

(52) U.S. Cl. CPC H05B 3/342; H05B 1/0236; B60J 11/04; H05B 2203/003; H05B 2203/014

(57) ABSTRACT

An electric tarp defroster includes a tarp material with integrated heating elements. The heating elements are embedded within a portion of the tarp material. A control unit is in communication with the heating element through wiring leads and is configured to regulate operation of the heating element. A remote electronic device is in wireless communication with the control unit. The remote electronic device is configured to transmit and receive data from the control unit and permit the selective activation of the heating element within the tarp material. The control unit includes one or more sensors being configured to detect inclement weather conditions and at least one of temperature and precipitation.

### CROSS REFERENCE TO RELATED APPLICATIONS

This application claims the benefit of an earlier filing date and right of priority to U.S. Provisional Application No. 63/511,489, filed 30 Jun. 2023, the contents of which is incorporated by reference herein in its entirety.

### BACKGROUND OF THE INVENTION

### 1. Field of the Invention

The present application relates to an electronic tarp defroster, and more particularly to a tarp with incorporated heating elements for the use of melting ice and snow.

### 2. Description of Related Art

The accumulation of ice on vehicles reduces the efficiency of the vehicle and can cause damage as well as to other vehicles in the vicinity when traveling. Tall vehicles are especially vulnerable to ice and snow buildup. It is difficult for an average human to see the top of a tall truck without climbing up and viewing the accumulation. During an ice and snow event, a dangerous buildup of ice and snow can accumulate without the operator's knowledge. Most large vehicles are stored outside in the weather, and the parked vehicle is a perfect candidate for ice and snow to build up on the roof and other inaccessible areas.

Removing a buildup of ice and snow can be very difficult, particularly ice. In many cases, if the weather is warm enough, the ice or snow may have melted slightly, only to refreeze as the temperature drops again. The ice and snow accumulation is dangerous to other drivers on the road as it may come off at speed and strike another vehicle with considerable force. Accumulating ice and snow can represent a substantial weight on the vehicle and affect fuel consumption efficiency. A particular concern for commercial trucks involved in far distance traveling.

Modern technology can solve the buildup of ice and snow on the top surface of vehicles by applying defrosting technology similar to what is available for the window of automobiles. Heating wires powered by the inboard power system of the truck, automobile, van, RV, bus, or practically any vehicle can be utilized to prevent the severe buildup of ice and snow on upper surfaces.

Although strides have been made, shortcomings remain.

### BRIEF SUMMARY OF THE INVENTION

It is an object of the present application to provide an electric tarp defroster that includes a tarp material with integrated heating elements. The heating elements are embedded within a portion of the tarp material. A control unit is in communication with the heating element through wiring leads and is configured to regulate operation of the heating element. A remote electronic device is in wireless communication with the control unit. The remote electronic device is configured to transmit and receive data from the control unit and permit the selective activation of the heating element within the tarp material. The control unit includes one or more sensors being configured to detect inclement weather conditions and at least one of temperature and precipitation.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of an electric tarp defroster according to an embodiment of the present application.

FIG. 2 is a perspective view of the electric tarp defroster of FIG. 1 in communication with a trailer body.

FIG. 3 is a perspective view of a control unit for the electric tarp defroster FIG. 1.

FIG. 4 is a perspective view of remote control devices to communicate with the control unit of FIG. 3.

FIG. 5 is a perspective view of the electric tarp defroster of FIG. 1 in communication with various vehicles.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

The Electric Tarp Defroster is an intelligent and practical approach to removing ice and snow buildup on a top surface of a vehicle. The Electric Tarp Defroster comprises a wiring harness mesh embedded into a tarp covering. A semi-trailer rig equipped with a rolling tarp cover would have the wire mesh embedded in the tarp roll. The wiring harness is flexible enough to withstand an indefinite number of times the tarp could be rolled and unrolled without any damage or harm to the wiring structure.

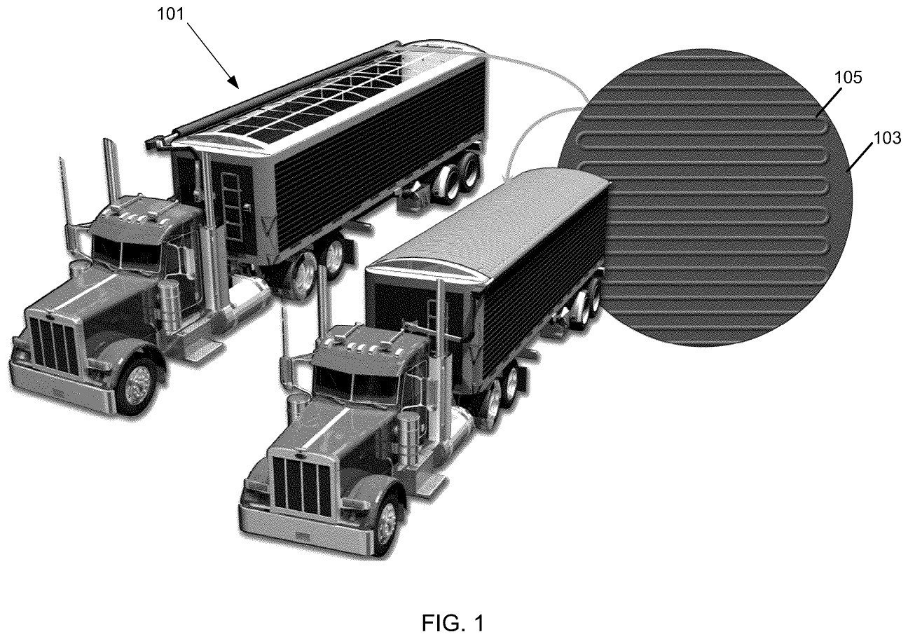

Referring now to FIG. 1 in the drawings, a perspective view of the electric tarp defroster 101 is illustrated. Defroster 101 is shown in communication with a semi-trailer and as shown in both an open position and a closed position. In the open position, defroster 101 is rolled away from the opening of the trailer. In the closed position defroster 101 is unraveled or unrolled so as to cover the top of the trailer. Defroster 101 includes a tarp material 103 having one or more heating elements 105 embedded therein. Electric energy is passed through heating elements 105 so as to induce a heat to melt ice and snow. This act prevents ice and snow from building up on top of an upper surface of defroster 101.

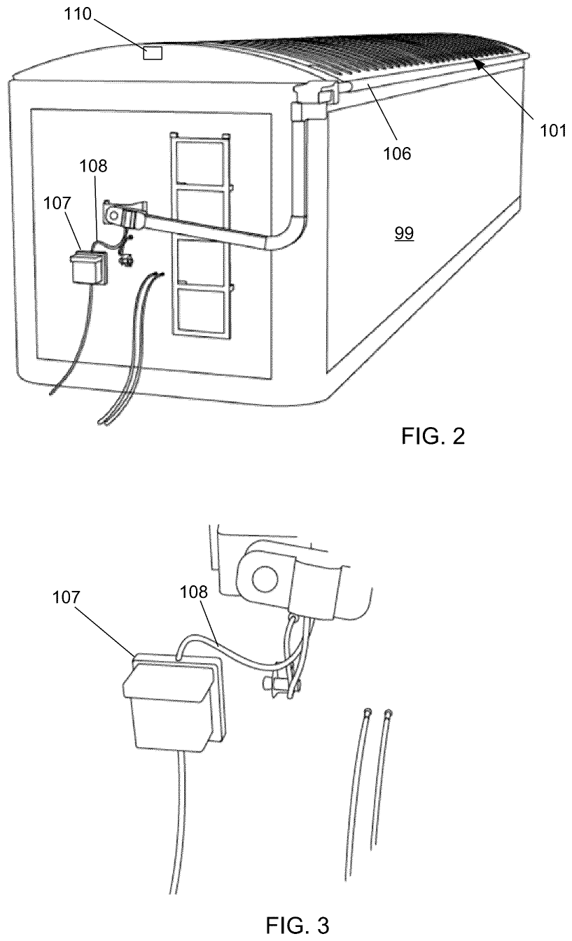

Referring now also to FIG. 2 in the drawings, a perspective view of defroster 101 on trailer 99 is illustrated. Defroster 101 is configured to operate on any surface wherein ice and snow is not desirable. Tarp material 103 may be sized to any dimensions, such as those commonly found with conventional tarps. Tarp material 103 may include multiple layers of material so as to cover heating elements 105 found therein. Heating elements 105 may be routed in any orientations and secured within the layers of tart material 103 through known techniques. Heating elements 105 exit a side or edge of material 103 via a connector or wire configured to accept a power supply.

It is understood that defroster 101 may be wrapped, rolled, folded, or stored in any compact form to allow for convenient transportation and storage. For example, the wiring harness is integrated into the tarp and is flexible enough to function on a roller system with wiring mesh shielded by layers of insulation. For power and control, a central control unit can be situated on the trailer's front, with wiring leads running up to the tarp and back to the vehicle. Upon use defroster 101 may be unraveled and aligned with a particular surface for selective heating.

Referring now also to FIG. 3 in the drawings, an enlarged prospective view of the control unit 107 in FIG. 2 is provided. Control and power to the Electric Tarp Defroster 101 are ideally provided by the vehicle through a wiring hook-up system that can easily be engaged and disengaged when necessary. The system could operate on either a 12- or 24-volt supply. A central control unit 107 is located adjacent material 103. In the embodiment seen in FIG. 2, such a location may be on the top of the trailer 99 with wiring leads 108 running up to the tarp material 103 and also back to the vehicle for power and control. A portable AC conversion kit may be used to convert the 12-volt system power to 110-volt power whenever vehicle power is not being used, usually when overnight parking or other circumstances occur.

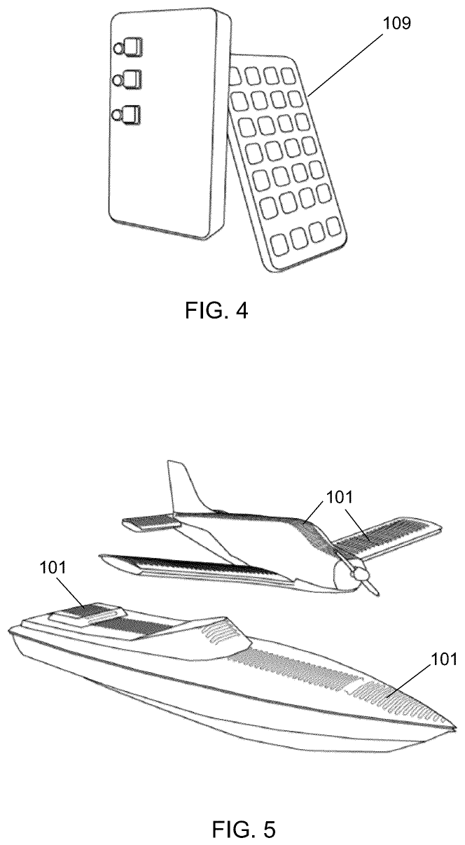

Referring now also to FIG. 4 in the drawings, one or more remote electronic devices are illustrated. Defroster 101 is operated either remotely or through manual control at the unit's main control box 107. The remote-control unit is either battery operated or can be hard-wired into the truck's electrical system or both. The remote 109 communicates with the central control unit 107 via wired or wireless communications. Control unit 107 is configured to monitor performance of heating elements 105. Remote 109 and control unit 107 are configured to transmit and receive data from each other to permit the selective activation and regulate operation of the heating element 105 so as to fully monitor performance of the heating element.

It is understood that control unit 107 may include multiple sensors 110 for the detection and monitoring of inclement weather and environmental conditions. These sensors 110 may be useful in automatically initiating heating elements 105 without having to require user input. The sensors can detect inclement weather, temperature, precipitation, and other factors. In one embodiment the unit functions automatically and/or manually to remind the operator that the system needs to be brought into operation. The system can be configured to operate automatically when the process of rolling the tarp over the trailer is activated when utilized as seen in FIGS. 1 and 2. An additional option is the handheld remote device 109 used to operate the Electric Tarp Defroster 101 through wireless operation. Defroster 101 can be controlled remotely or manually at the unit's main control box. The remote-control device may be either battery-powered or hard-wired into the truck's electrical system, or both, and the handheld remote can be used from up to 50 feet away.

Usage of remote 109 may permit the transmission of command data to selectively designate particular functions and operations from distances up to 50 feet away for example. Remote 109 may be operable through Bluetooth or other smartphone applications. Control unit 107 is configured to include hardware to operate and monitor sensors and process communications from remote 109. It is understood that permitted temperatures and other settings may be preset or alterable through one or more user interfaces associated with control unit 107.

Referring now also to FIG. 5 in the drawings, perspective views of defrost or 101 in association with other vehicles are provided. Other uses for the Electric Tarp Defroster 101 include any type of vehicle constantly exposed to the weather. The vehicles include tractor-trailer rigs, RVs, buses, large and small aircraft, boats, and other machines that are operated in low-temperature, wet and icy environments. The Electric Tarp Defroster 101 will increase the efficiency and overall safety of many types of vehicles with or without automatic tarp covering systems.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. An electric tarp defroster, comprising:
a tarp material;
a heating element embedded within a portion of the tarp material; and
a control unit in communication with the heating element through wiring leads, the control unit configured to regulate operation of the heating element.

2. The defroster of claim 1, wherein the tarp material includes a plurality of layers.

3. The defroster of claim 1, wherein the tarp material covers the heating element.

4. The defroster of claim 1, wherein the heating element is operable through a 12-volt power supply.

5. The defroster of claim 1, wherein the heating element is operable through a 24-volt power supply.

6. The defroster of claim 1, wherein the heating element is in electrical communication with a vehicle power supply.

7. The defroster of claim 1, further comprising:
a portable AC conversion kit to adjust the electrical supply to a 110-volt power supply.

8. The defroster of claim 1, further comprising:
a remote electronic device in wireless communication with the control unit, the remote electronic device configured to transmit and receive data from the control unit and permit the selective activation of the heating element within the tarp material.

9. The defroster of claim 1, wherein the control unit is configured to monitor performance of the heating element.

10. The defroster of claim 9, wherein the control unit is configured to automatically turn on and off the heating element.

11. The defroster of claim 9, wherein the control unit is configured to selectively adjust the temperature of the heating element.

12. The defroster of claim 1, wherein the control unit includes one or more sensors.

13. The defroster of claim 12, wherein the one or more sensors is configured to detect inclement weather conditions.

14. The defroster of claim 12, wherein the one or more sensors is configured to detect at least one of temperature and precipitation.

15. An electric tarp defroster, comprising:
a tarp material;
a heating element embedded within a portion of the tarp material;
a control unit in communication with the heating element through wiring leads, the control unit configured to regulate operation of the heating element;
a remote electronic device in wireless communication with the control unit, the remote electronic device configured to transmit and receive data from the control unit and permit the selective activation of the heating element within the tarp material; and
one or more sensors in communication with the control unit being configured to detect inclement weather conditions and at least one of temperature and precipitation.
